(19) United States
(12) Patent Application Publication
(10) Pub. No.: US 2013/0004266 A1
(43) Pub. Date: Jan. 3, 2013

(54) Device for Managing Solder Paste

(75) Inventors: Shao-Chun Chang, Taoyuan County (TW); Ching-Feng Hsieh, Taipei (TW)

(73) Assignees: Askey Computer Corporation, New Taipei City (TW); Askey Technology (Jiangsu) Ltd., JiangSu Province (CN)

(21) Appl. No.: 13/243,200

(22) Filed: Sep. 23, 2011

(30) Foreign Application Priority Data
Jun. 30, 2011 (TW) 100123047

(51) Int. Cl. B65G 11/06; B65G 11/20; B65G 11/00

(52) U.S. Cl. 414/148; 414/147; 414/151

(57) ABSTRACT

A device for managing solder paste includes a storage room, a warm up room, a preparing room and a central control device, wherein the storage room, the warm up room and the preparing room respectively have a transportation unit for delivering a solder paste can. There are reading devices disposed respectively at an inlet/outlet of the above rooms for reading information of the solder paste can when the solder paste can passes thereby, and the central control device updates storage information for the solder paste cans. The central control device may access production information of a production line from a production managing system, and thus analyze the mold number and amount of solder paste cans, receive the solder paste cans based on a first-in, first-out manner, and deliver the solder paste cans to the warm up room for the warm up treatment.

### BACKGROUND OF THE INVENTION

1. Field of the Invention

The present invention relates to a device for managing solder paste, and more particularly, to a device for managing storage, a warm up treatment and receiving of solder paste.

2. Description of Related Art

There are strict requirements for storage and usage of solder paste in industry. For example, the storage temperature is controlled to be 2-8° C.; solder paste is stored in a can for up to 6 months before the can is open; and before opening the can, the solder paste needs to be warm up to room temperature (25±2° C.), wherein time for warming up the solder paste is about 4 hours, and no heating device is allowed for warming up the solder paste. Currently, the storage and usage of solder paste is manually controlled; however, it is hard to control quality and maintenance of solder paste. Further, since the storage and warm up of solder paste are manually controlled, the quality of solder paste would be poor due to improper warm up, and the manual management would increase cost.

Accordingly, there is a need to a device for managing storage and usage of solder paste.

### SUMMARY OF THE INVENTION

The present invention provides a device for managing solder paste, so as to improve management of solder paste and lower labor cost.

The device for managing solder paste includes a storage room having an inlet, an outlet and a first transportation unit, wherein the first transportation unit is used for delivering a solder paste can from the inlet to the outlet; a warm up room connected to the outlet of the storage room, having a warm up outlet and a second transportation unit, wherein the second transportation unit is used for the solder paste can from the outlet of the storage room for a warm up treatment and to the warm up outlet; a preparing room connected to the warm up outlet and having a receiving portion and a third transportation unit, wherein the third transportation unit is used for delivering the solder paste can from the warm up outlet; a plurality of reading devices respectively disposed at the inlet of the storage room, the outlet of the storage room, the warm up outlet of the warm up room and the receiving portion of the preparing room for accessing information while the solder paste can passes through the inlet of the storage room, the outlet of the storage room, the warm up outlet of the warm up room and the receiving portion of the preparing room; and a central control device for monitoring a status of the storage room and the warm up room, and control transportation of the solder paste can from the storage room to the warm up room and the preparing room.

In one embodiment, the first, second or third transportation unit is a spiral-shaped stand for arranging solder pastes cans in a spiral arrangement. In another embodiment, the first, second or third transportation unit is a z-shaped stand.

In the device for managing solder paste, the central control device has a data bank and a monitoring unit, wherein the data bank is used for storing storage information having an expiration date of the solder paste can, and the monitoring unit monitors whether the solder paste can in the storage room expires. If the solder paste can expires, the monitoring unit outputs an alert message.

In the device for managing solder paste, the data bank is used for storing storage information and setting information including a storage condition and a warm up condition of the solder paste can, wherein the storage information includes a mold number of the solder paste can, a date at which solder paste is placed into the solder paste can, and a storage amount of the solder paste can, and the monitoring unit outputs an alert message if a temperature of the storage room/warm up room fails to meet the storage condition/the warm up condition.

In the device for managing solder paste, the central control device further comprises a switch control unit for controlling the inlet of the storage room, the outlet of the storage room, the warm up outlet of the warm up room and the receiving portion of the preparing room to be open or close.

In the device for managing solder paste, while the outlet of the storage room and the warm up outlet of the warm up room are open, the solder paste can rolls by gravity on the stand from the storage room to the warm up room or from the warm up room to the preparing room.

Hence, the device of the present invention may be operated with a system for delivering a solder paste can to be needed from a storage room to a warm up room for a warm up treatment, and automatically monitoring the storage temperature, expiration date and warm up treatment of the solder paste can, so as to ensure quality of the solder paste and further to effectively manage solder paste usage and lower labor cost.

### BRIEF DESCRIPTION OF THE DRAWINGS

FIG. 1 is a schematic view showing the device for managing solder paste according to an embodiment of the present invention.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

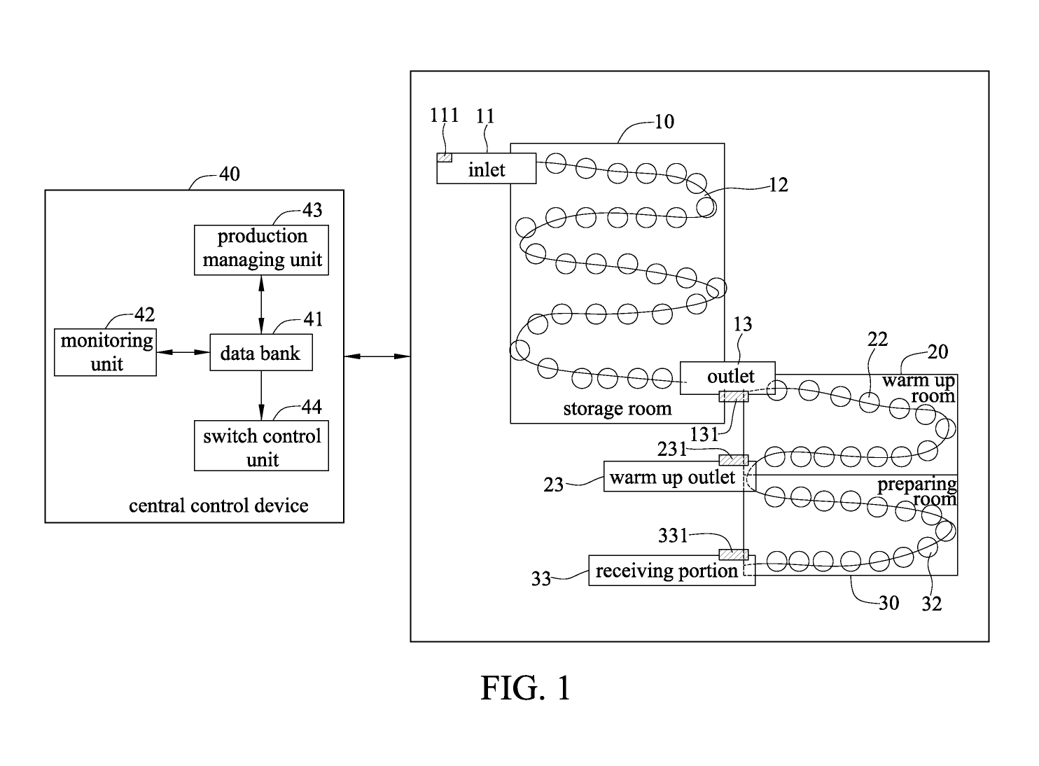

FIG. 1 is a schematic view showing a device for managing solder paste. As shown in FIG. 1, the device for managing solder paste includes a storage room 10, a warm up room 20, a preparing room 30 and a central control device 40.

The storage room 10 is used for storing solder paste cans. In this embodiment, the storage room 10 has an inlet 11, an outlet 13 and a first transportation unit 12. The transportation unit 12 is used for delivering solder paste cans from the inlet 11 to the outlet 13. In this embodiment, the first transportation unit 12 is a spiral-shaped stand for arranging solder paste cans in a spiral arrangement. In another embodiment, the first transportation unit 12 is z-shaped, such that the solder paste cans arranged on the first transportation unit 12 may be delivered in a single direction, i.e. in a first-in, first-out manner.

The warm up room 20 is connected to the outlet 13 of the storage room for warming up solder paste. In this embodiment, the warm up room 20 has a warm up outlet 23. The warm up room 20 has a second transportation unit 22. The design of the second transportation unit 22 is similar to that of the first transportation unit 12 in the storage room 10. The second transportation unit 22 is used for delivering the solder paste can from the outlet 13 of the storage room 10 for a warm up treatment, and then delivering the solder paste can to the warm up outlet 23.

The preparing room 30 is connected to the warm up outlet 23 of the warm up room, and the solder paste can after the warm up treatment is placed in the preparing room. The preparing room 30 has a receiving portion 33 for a staff to receive the solder paste can, which has been warmed up. The preparing room 30 further has a third transportation unit 32 similar to the first transportation unit 12.

In addition, there are reading devices respectively disposed at the inlet 11 and the outlet 13 of the storage room 10, the warm up outlet 23 of the warm up room 20, and the receiving portion 33 of the preparing room 30. In this embodiment, the reading devices are scanning devices 111, 131, 231 and 331. In this embodiment, when the solder paste can passes through the inlet 11 and the outlet 13 of the storage room 10, the warm up outlet 23 of the warm up room 20, and the receiving portion 33 of the preparing room 30, the respective reading device reads the bar code on the solder paste can to obtain information of the solder paste can, such that the central control device 40 may perform processing based on the obtained information.

The central control device includes a data bank 41, a monitoring unit 42, a production managing unit 43 and a switch control unit.

The data bank 4 is used for storing the storage information, setting information of storage conditions and setting information of warm up conditions for each solder paste can. The storage information includes a mold number of each solder paste can, a date at which solder paste is placed into the solder paste can, a storage amount of each solder paste can, and an expiration date. The setting information of storage conditions for each solder paste can includes a storage temperature, and the setting information of warm up conditions for each solder paste can includes time duration of warm up and warm up warning time.

The monitoring unit 42 is connected to the data bank 41 for collecting the obtained information from the scanning devices (111, 131, 231, 331), and updating the storage information of the solder paste can stored in the data bank 41. In other words, when the solder paste can is delivered from the inlet 11 to the storage room 10, the scanning device 111 scans the bar code of the solder paste can so as to obtain the mold of the solder paste can, the date at which the solder paste is placed into the solder paste can, the expiration date, and the storage amount of the solder paste can, then records such information in the data bank 41, and establishes corresponding storage information for the solder paste can in the data bank 41. When the solder paste can passes through the outlet 13, the monitoring unit 42 updates the storage information for the solder paste can in the data bank 41 according to the information obtained from the scanning device 131 at the outlet 13. For example, the status of the solder paste can is updated from a storage status to a warm up status. Similarly, when the solder paste can passes through the warm up outlet 23 or the receiving portion 33, the information of the solder paste can is obtained by the scanning device 231 or the scanning device 331, and then the storage information for the solder paste can in the data bank 41 is immediately updated, wherein the storage information may be standby status for being received or having been received status.

The monitoring unit 42 is used for monitoring the temperature of the storage room 10 and the warm up room according to the setting information of storage conditions and setting information for warm up conditions for the solder paste can in the data bank 41. Further, the monitoring unit 42 is used for outputting an alert message when the temperature of the storage room 10/the warm up room 20 fails to meet the storage condition/the warm up condition. The monitoring unit 42 is also used for monitoring whether the solder paste can expires according to the expiration date stored in the data bank 41. If the solder paste can expires, the monitoring unit 42 outputs an alert message to notify a management staff, so as to avoid using the expired solder paste.

The production managing unit 43 is connected to the production managing system (not shown) for accessing production information (such as a production schedule) from the production managing system, analyzing and calculating the mold number and amount of the solder paste cans in need, inquiring the solder paste cans according to the storage information in the data bank and the analysis result and based on a first-in, first-out manner, and automatically delivering the inquired solder paste cans from the storage room 100 to the warm up room 20. In this embodiment, when the outlet 13 of the storage room 10 is open, the solder paste can rolls into the next region (i.e. the warm up room 20) by gravity, and recording and calculating the warm up time for the solder paste cans according to the warm up condition in the data bank 41. During the warm up treatment, the temperature of the warm up room 20 is monitored. The solder paste cans after the warm up treatment are delivered from the warm up outlet 23 to the preparing room 30, and then received by the staff via the receiving portion 33.

Moreover, the device for managing solder paste includes a switch unit 44 for controlling on and off of the inlet 11 of the storage room 10, the outlet 13 of the storage room 10, the warm up outlet 23 of the warm up room 2 and the receiving portion 33 of the preparing room 30.

In another embodiment, the information of the solder paste can may be presented on a radio frequency identification (RFID) tag, and the scanning devices (111, 131, 231, 331) may be RFID reading devices.

Accordingly, the storage room and the warm up treatment for a solder paste can are automatically controlled by a system via the device for managing solder paste in the present invention, so as to avoid using a solder paste can with poor quality. Furthermore, production information of a production line is accessed from a production managing system, the amount of solder paste cans, which are needed, is calculated and obtained, then inquiring is performed to obtain the solder paste cans which meet the analysis result and meet the first-in, first-out manner, the solder paste cans are delivered to the warm up room, and the warm up treatment is monitored. Therefore, the storage and warm up of solder paste is systematically managed, such that efficacy of management is improved, labor cost is reduced, and usage of solder paste is effectively managed.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A device for managing solder paste, comprising:
a storage room having an inlet, an outlet, and a first transportation unit that delivers solder paste can from the inlet to the outlet;
a warm up room connected to the outlet of the storage room and having a warm up outlet and a second transportation unit that delivers the solder paste can from the outlet of the storage room for a warm up treatment and to the warm up outlet;
a preparing room connected to the warm up outlet and having a receiving portion and a third transportation unit that delivers the solder paste can from the warm up outlet;
a plurality of reading devices respectively disposed at the inlet of the storage room, the outlet of the storage room, the warm up outlet of the warm up room and the receiving portion of the preparing room for accessing information while the solder paste can passes through the inlet of the storage room, the outlet of the storage room, the warm up outlet of the warm up room and the receiving portion of the preparing room; and
a central control device for monitoring a status of the storage room and the warm up room, and control transportation of the solder paste can from the storage room to the warm up room and the preparing room.

2. The device of claim 1, wherein at least one of the first, second, and third transportation units is a spiral-shaped stand that arranges solder pastes cans in a spiral arrangement.

3. The device of claim 1, wherein while the outlet of the storage room and the warm up outlet of the warm up room are open, the solder paste can rolls by gravity on the spiral-shaped stand from the storage room to the warm up room or from the warm up room to the preparing room

4. The device of claim 1, wherein at least one of the first, second and third transportation units is a z-shaped stand for delivering the solder paste can in a single direction.

5. The device of claim 4, wherein while the outlet of the storage room and the warm up outlet of the warm up room are open, the solder paste can rolls by gravity on the z-shaped stand from the storage room to the warm up room or from the warm up room to the preparing room

6. The device of claim 1, wherein the central control device has a data bank and a monitoring unit, the data bank is used for storing storage information having an expiration date of the solder paste can, and the monitoring unit monitors whether the solder paste can in the storage room expires.

7. The device of claim 6, wherein the monitoring unit is further used for outputting an alert message while the solder paste can expires.

8. The device of claim 1, wherein the central control device has a data bank and a monitoring unit, the data bank is used for storing storage information and setting information including a storage condition and a warm up condition of the solder paste can, wherein the storage information includes a mold number of the solder paste can, a date at which solder paste is placed into the solder paste can, and a storage amount of the solder paste can, and the monitoring unit outputs an alert message if a temperature of the storage room/warm up room fails to meet the storage condition/the warm up condition.

9. The device of claim 1, wherein the central control device further comprises a switch control unit for controlling the inlet of the storage room, the outlet of the storage room, the warm up outlet of the warm up room and the receiving portion of the preparing room to be open or close.

10. The device of claim 1, wherein the reading device are scanning devices for identifying a bar code on the solder paste can.

11. The device of claim 1, wherein the reading device are RFID reading devices for identifying an RFID tag.
